(19) United States
(12) Patent Application Publication
(10) Pub. No.: US 2006/0286407 A1
(43) Pub. Date: Dec. 21, 2006

(54) Fluorescent pattern forming article, recording medium, security medium, and recording method

(75) Inventors: Akio Amano, Kawasaki-shi (JP); Hiroki Iwanaga, Yokohama-shi (JP); Koichi Harada, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: Kabushiki Kaisha Toshiba, Minato-ku (JP)

(21) Appl. No.: 11/453,471

(22) Filed: Jun. 15, 2006

(30) Foreign Application Priority Data
Jun. 16, 2005 (JP) 2005-176427

(51) Int. Cl. B32B 19/00

(52) U.S. Cl. 428/690

(57) ABSTRACT

A fluorescent pattern forming article including a first layer containing a metal ion, and a second layer disposed facing the first layer and containing a ligand coordinating with the metal ion contained in the first layer to thereby enable an intensity of fluorescence based on the metal ion to be changed.

### CROSS-REFERENCE TO RELATED APPLICATIONS

This application is based upon and claims the benefit of priority from prior Japanese Patent Application No. 2005-176427, filed Jun. 16, 2005, the entire contents of which are incorporated herein by reference.

### BACKGROUND OF THE INVENTION

1. Field of the Invention

This invention relates to a fluorescent pattern forming article, a recording medium, a security medium, and a recording method. In particular, this invention relates to a fluorescent pattern forming article comprising a metal ion and a ligand coordinated with the metal ion, to a recording medium comprising the fluorescent pattern forming article, to a security medium comprising the fluorescent pattern forming article, and to a recording method using the recording medium.

2. Description of the Related Art

In recent years, peoples have become increasingly aware of the importance of security technology, and hence the development of security technology is now being intensively undertaken. The reasons for this trend can be attributed to increasing need to prevent forgery or duplication and to increasing need to record confidential information in order to maintain security. There has been proposed a security system employing a fluorescent compound, which is characterized in that although it is impossible to visually recognize confidential information included in a printed matter under visible light, it is possible to visually recognize the confidential information as the printed matter is irradiated with ultraviolet lays (see for example, JP-A 2002-173622. Although such a technology is certainly useful to some extent, there is a persistent demand for more advanced security in order to meet the cases where much higher confidentiality is required.

As means for enhancing security, there has been proposed a multicoloration system (see for example, JP-A 2003-340954). However, the multicoloration leads to the requirement of sophistication of detector and raises the problem that it is impossible to realize automated treatment if the detection is required to be performed by one's eyes.

As for one of the means to enhance the security by making use of monochrome, it is conceivable to employ a method of enhancing the contrast ratio of fluorescence. However, the method seems to be accompanied by various problems that if the contrast ratio is to be enhanced by adjusting the concentration of fluorescent substance, various kinds of ink are prepared depending on the concentration of fluorescent substance, thus making the method very difficult to actually realize, and if the contrast ratio is to be enhanced by adjusting the quantity of ink to be applied, the configuration of ink may be reflected on the printed surface, thus degrading the security.

Incidentally, there has been practiced to record and indicate information regarding manufacturers and trade names by making use of marks such as bar codes which can be read out by optical means, thereby making it possible to analyze the sale of products and the current state of marketing. In these fields also, fluorescent compounds are used as a material for recording and marking a product for the purpose of enhancing the visual recognition or for the convenience of adjusting the composition of ink (see for example, JP-A 2000-144029. In the case where the recording and marking are generally performed using fluorescent compounds as described above also, it is required to perform the recording with enhanced security especially if the information to be recorded or marked contains confidential information. Therefore, the deterioration, if any, of security mentioned above may raise a serious problem.

### BRIEF SUMMARY OF THE INVENTION

Therefore, an object of the present invention is to provide a fluorescent pattern forming article which is excellent in security and can be conveniently detected.

According to a first aspect of the present invention, there is provided a fluorescent pattern forming article comprising a first layer containing a metal ion; and a second layer disposed facing the first layer and containing a ligand coordinating with the metal ion contained in the first layer to thereby enable an intensity of fluorescence based on the metal ion to be changed.

According to a second aspect of the present invention, there is provided a fluorescent pattern forming article comprising: a first layer containing a metal ion; a second layer disposed facing the first layer and containing a ligand coordinating with the metal ion contained in the first layer to thereby enable an intensity of fluorescence based on the metal ion to be increased; and a third layer interposed between the first and second layers and containing a fluorescent compound having the metal ion and the ligand coordinated with the metal ion, the fluorescent compound being formed into a pattern.

According to a third aspect of the present invention, there is provided a fluorescent pattern forming article comprising: a first layer containing a first complex having a metal ion and fluorescent properties and functioning as a fluorescent layer; a second layer disposed facing the first layer and containing a ligand coordinating with the metal ion of the first complex contained in the first layer to thereby enable an intensity of fluorescence based on the metal ion to be decreased; and a partitioning layer interposed between the first and second layers for separating these layers from each other, the partitioning layer containing a second complex having the ligand coordinated with the metal ion of the first complex, the second complex being formed into a pattern.

According to a fourth aspect of the present invention, there is provided a recording medium which is capable of recording information as a distribution of fluorescent intensity, the recording medium comprising a first layer containing a metal ion; and a second layer disposed facing the first layer and containing a ligand coordinating with the metal ion contained in the first layer to thereby enable an intensity of fluorescence based on the metal ion to be changed.

According to a fifth aspect of the present invention, there is provided a security medium which is capable of recording security information as a distribution of fluorescent intensity, the recording medium comprising a first layer containing a metal ion; and a second layer disposed facing the first layer and containing a ligand coordinating with the metal ion contained in the first layer to thereby enable an intensity of fluorescence based on the metal ion to be changed.

According to a sixth aspect of the present invention, there is provided a recording method for performing recording of information onto a fluorescent pattern forming article comprising a first layer containing a metal ion; and a second layer disposed facing the first layer and containing a ligand coordinating with the metal ion contained in the first layer and enabling an intensity of fluorescence based on the metal ion to be changed; the method comprising a step of externally applying at least one kind of energy selected from heat, stress and light to the fluorescent pattern forming article to enable the ligand of the second layer to be coordinated with the metal ion of the first layer, thereby changing the intensity of fluorescence to perform the recording of information.

### BRIEF DESCRIPTION OF THE SEVERAL VIEWS OF THE DRAWING

FIGS. 1A and 1B respectively illustrate a cross-sectional view of the structure of a fluorescent pattern forming article according to a first embodiment of the present invention;

FIGS. 2A and 2B respectively illustrate a cross-sectional view of the structure of a fluorescent pattern forming article according to a second embodiment of the present invention;

FIGS. 3A and 3B respectively illustrate a cross-sectional view of the structure of a fluorescent pattern forming article according to a third embodiment of the present invention;

FIGS. 4A and 4B respectively illustrate a cross-sectional view of the structure of a fluorescent pattern forming article according to a fourth embodiment of the present invention;

FIGS. 5A and 5B respectively show a cross-sectional view schematically illustrating the structure of a device for externally applying heat and stress to a fluorescent pattern forming article of the present invention;

FIGS. 6A and 6B respectively illustrate a cross-sectional view of the structure of a fluorescent pattern forming article according to a fifth embodiment of the present invention;

FIGS. 7A and 7B respectively illustrate a cross-sectional view of the structure of a fluorescent pattern forming article according to a sixth embodiment of the present invention; and

FIGS. 8A and 8B respectively illustrate a cross-sectional view of the structure of a fluorescent pattern forming article according to a ninth embodiment of the present invention.

### DETAILED DESCRIPTION OF THE INVENTION

The fluorescent pattern forming article according to a first embodiment of the present invention is characterized in that it comprises: a first layer containing a metal ion; and a second layer disposed facing the first layer and containing a ligand coordinating with the metal ion contained in the first layer to thereby enable an intensity of fluorescence based on the metal ion to be changed.

A partitioning layer may be interposed between the first and second layers for separating these layers from each other.

Further, the fluorescent pattern forming article according to a second aspect of the present invention is characterized in that it comprises: a first layer containing a metal ion; a second layer disposed facing the first layer and containing a ligand coordinating with the metal ion contained in the first layer to thereby enable an intensity of fluorescence based on the metal ion to be increased; and a third layer formed into a pattern and interposed between the first and second layers, the third layer containing a fluorescent compound having the metal ion and the ligand coordinated with the metal ion.

In the fluorescent pattern forming article according to a second aspect of the present invention, a partitioning layer for separating the first layer from the second layer may be interposed between the first and second layers. This partitioning layer may contain a fluorescent compound, thus enabling at least a portion of the partitioning layer to act also as a fluorescent layer.

Furthermore, the metal ion contained in the first layer and/or the ligand contained in the second layer may be enabled to diffuse into a region other than the predetermined pattern of the fluorescent layer interposed between the first and second layers, thereby making it possible to control the intensity of fluorescence based on the metal ion so as to make it become homogeneous throughout the entire surface after a predetermined period of time.

Still more, the fluorescent pattern forming article according to a third aspect of the present invention is characterized in that it comprises: a first layer containing a first complex having fluorescent properties and hence functioning as a fluorescent layer; a second layer disposed facing the first layer and containing a ligand coordinating with the metal ion of the first complex of the first layer to thereby enable an intensity of fluorescence based on the metal ion to be decreased; and a layer formed into a pattern, interposed between the first and second layers, and containing a second complex having the ligand coordinated with the metal ion of the first complex.

In the fluorescent pattern forming article according to a third aspect of the present invention, it may further comprise a partitioning layer interposed between the first and second layers for separating these layers from each other, the partitioning layer containing the first complex and the ligand.

The first complex contained in the first layer and/or the ligand contained in the second layer may be enabled to diffuse into a region other than the predetermined pattern of the layer containing the second complex and interposed between the first and second layers to thereby enable the intensity of fluorescence based on the metal ion to become homogeneous throughout the entire surface after a predetermined period of time.

Further, the fluorescent pattern forming articles according to the first, second and third aspects of the present invention described above may be constructed as follows.

(1) The first layer and/or the second layer may be formed into a pattern.

(2) The fluorescent pattern forming may further comprise a partitioning layer interposed between the first and second layers for separating these layers from each other, the partitioning layer being formed into a pattern corresponding to at least one of the patterns of the first layer and/or the second layer.

(3) The fluorescent pattern forming article may further comprise a protective layer for covering the first layer and/or the second layer that has been formed into the predetermined pattern.

(4) The fluorescent pattern forming article may further comprise a supporting substrate attached respectively to the first layer and/or the second layer.

(5) The fluorescent pattern forming article may further comprise a supporting substrate attached respectively to the first layer and/or the second layer, and a reflective film interposed between the supporting substrate and the first layer and/or the second layer.

(6) The fluorescent pattern forming article may further comprise a transparent substrate attached respectively to one main surface of the first layer and/or the second layer, and a reflective film attached respectively to the other main surface of the first layer and/or the second layer.

(7) The fluorescent layer of the fluorescent pattern forming article may be constructed such that it is capable of emitting fluorescence as it is irradiated with ultraviolet rays and is substantially transparent to visible light.

(8) The first layer and/or the second layer of the fluorescent pattern forming article may be constructed such that it is substantially transparent to visible light.

(9) The fluorescent pattern forming article may further comprise a partitioning layer interposed between the first and second layers for separating these layers from each other, the partitioning layer being substantially transparent to visible light.

(10) The metal ion may be formed of at least one kind of metal selected from rare earth metals, indium, gallium, palladium, platinum, ruthenium, copper, zinc and aluminum.

(11) The metal ion may be included as a metal ion complex in the first layer.

(12) The ligand may be enabled to act to increase the intensity of fluorescence based on the metal ion metal ion as it is coordinated with the metal ion of the first layer, the ligand being at least one kind of compound selected from the group consisting of a phosphine oxide compound, a sulfoxy compound, a carboxylic compound, a carbonyl compound, phenanthroline, bipyridine, and an acetylacetonato compound.

(13) The ligand may be enabled to act to decrease the intensity of fluorescence based on the metal ion metal ion as it is coordinated with the first complex of the first layer, the ligand being at least one kind of compound selected from the group consisting of a hydroxy compound and water.

There is also provided a recording medium which is capable of recording information as a distribution of fluorescent intensity onto each of the fluorescent pattern forming articles according to the aforementioned first, second and third aspects of the present invention.

There is also provided a security medium which is capable of recording security information as a distribution of fluorescent intensity onto each of the fluorescent pattern forming articles according to the aforementioned first, second and third aspects of the present invention.

There is also provided a recording method which comprises a step of externally applying at least one kind of energy selected from heat, stress and light onto each of the fluorescent pattern forming articles according to the aforementioned first, second and third aspects of the present invention, thereby enabling the ligand of the second layer to coordinate with the metal ion of the first layer, thereby changing the intensity of fluorescence to perform the recording of information.

According to the present invention, it is possible to provide a fluorescent pattern forming article which is excellent in security and can be conveniently detected.

Various embodiments of the present invention will be specifically explained with reference to the drawings.

### First Embodiment

This first embodiment is characterized in that a distribution of the intensity of fluorescence is caused to generate as energy of heat or stress is externally applied to a fluorescent pattern forming article.

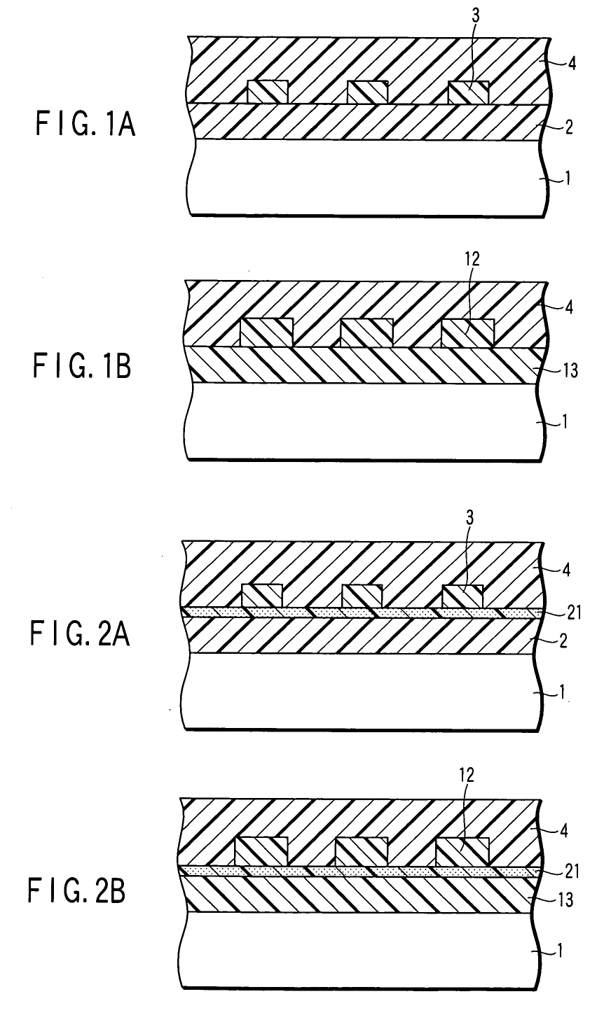

FIGS. 1A and 1B respectively illustrates a cross-sectional view of the structure of the fluorescent pattern forming article according to this embodiment.

As shown in FIG. 1A, on a substrate 1 employed as a base body and formed of paper, polyethylene terephthalate (PET) resin, acrylic resin, polycarbonate resin, aluminum foil, glass, etc., there is laminated a metal ion-containing resin layer 2 formed, as a first layer, of a transparent resin containing therein a metal ion (including a metallic complex). Although trivalent Eu ion is incorporated as a metal ion in this metal ion-containing resin layer 2, this Eu ion is incorporated therein in a state of Eu complex wherein an acetylacetonato derivative (β-diketone derivative) as represented by the following formula (1) is coordinated with this Eu ion.

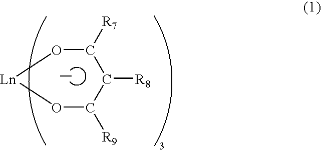

In formula (1), Ln is a rare earth element (for example, Eu, Tb or Er); R₇ and R₉ may be the same or different and are individually a straight or branched alkyl or alkoxy group, phenyl group, biphenyl group, naphthyl group, heterocyclic group, or a substituted group comprising any of these groups (for example, substituted alkyl groups such as n-C₄F₉, t-C₄F₉, etc.); and R₈ is halogen atom, deuterium atom or a straight or branched aliphatic group having 1 to 22 carbon atoms.

The transparent resin to be employed as the metal ion-containing resin layer 2 is substantially transparent to visible light and may be formed of transparent fluorinated polymer. For example, when Cefral (trademark, Central Glass Co., Ltd.) is employed as a transparent resin, the content of the aforementioned Eu complex in the metal ion-containing resin layer 2 may be 20% by weight.

On this metal ion-containing resin layer 2 is formed, as a second layer, a predetermined pattern of ligand-containing resin layer 3 comprising a transparent resin in which a ligand (one kind of phosphine oxide compound) shown by the following formula (2) is included. The ligand in the ligand-containing resin layer 3 is enabled to coordinate with the Eu ion of Eu complex represented by the above-described formula (1) and included in the metal ion-containing resin layer 2, thus forming the Eu complex (a fluorescent compound) represented by the following formula (3) and increasing the intensity of fluorescence based on the Eu ion. Especially, as plural kinds (two kinds in particular) of phosphorus compounds differing in structure from each other within the following formula (2) are coordinated with a single rare earth atom, the ligand field would become increasingly asymmetrical, resulting in the enhancement of molecular extinction coefficient and in a prominent increase in intensity of luminescence.

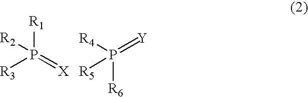

In formula (2), X and Y may be the same or different and are individually O, S or Se (for example, O); R₁ to R₆ may be the same or different and are individually a straight or branched alkyl or alkoxy group, phenyl group, biphenyl group, naphthyl group, heterocyclic group, or a substituted group comprising any of these groups. Although a combination of R₁ to R₃ may be the same with a combination of R₄ to R₆, it is more preferable in terms of luminescent intensity that a combination of R₁ to R₃ differs from a combination of R₄ to R₆ (for example, each group of R₁ to R₃ is formed of n-O_{c} (octyl) group, and each group of R₄ to R₆ is formed of phenyl group).

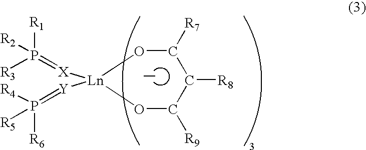

The transparent resin to be employed as the ligand-containing resin layer 3 is also substantially transparent to visible light and may be formed of transparent fluorinated polymer. For example, when Cefral (trademark, Central Glass Co., Ltd.) is employed as a transparent resin, the content of the ligand in the ligand-containing resin layer 3 may be 20% by weight. Incidentally, a protective film 4 formed of PET resin, acrylic resin, polycarbonate resin, glass, etc. is formed so as to cover the metal ion-containing resin layer 2 and the ligand-containing resin layer 3. This protective film 4 is also substantially transparent to visible light.

Next, there will be explained about the method for performing the recording of information, which can be executed by forming a fluorescent pattern on the fluorescent pattern forming article shown in FIG. 1A. In this embodiment, a distribution of the intensity of fluorescence is caused to generate on the surface of fluorescent pattern forming article by externally applying energy of heat or stress to the fluorescent pattern forming article. Namely, through the application of heating or pressing, the ligand of the ligand-containing resin layer 3 is caused to coordinate with the metal ion of the metal ion-containing resin layer 2 to thereby form a complex exhibiting a high fluorescent intensity, thereby making it possible to perform the recording of information through this increased fluorescent intensity.

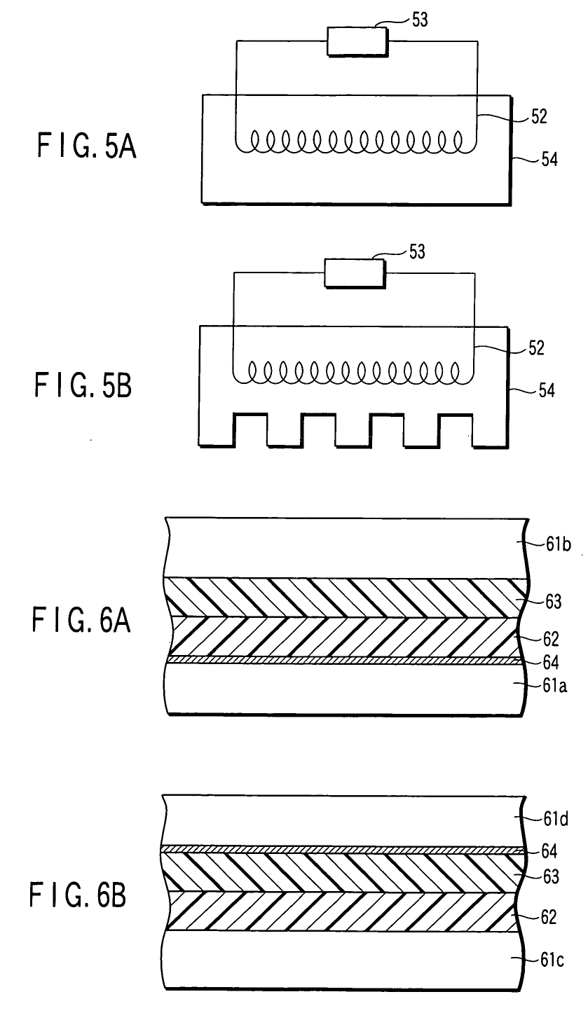

More specifically, the recording of information is performed as follows. First of all, the fluorescent pattern forming article as shown in FIG. 1A is placed on a base plate and then a heating plate is pressed onto the surface of the protective film 4 of this fluorescent pattern forming article. The heating plate may be constructed as shown in FIGS. 5A and 5B. FIG. 5A is a cross-sectional view illustrating the construction of the heating plate having a flat contacting surface. FIG. 5B is a cross-sectional view illustrating the construction of the heating plate having a recessed/projected contacting surface. As shown in FIG. 5A, a heater 52 is embedded in the heating plate 51 having a flat contacting surface and connected with a power source 53, thereby enabling the heating plate 51 to be heated as a voltage is applied to the heater 52. The heating plate 54 shown in FIG. 5B is provided with a recessed/projected contacting surface. If the heating plate 51 of FIG. 5A is to be employed, the contacting surface of heating plate 51 can be pressed onto the surface of the protective film 4 as it is. Whereas, if the heating plate 54 of FIG. 5B is to be employed, the pattern of the projected portions of the contacting surface of heating plate 54 should preferably be configured to conform with the pattern (all or part of the pattern) of the ligand-containing resin layer 3, so that the pattern of the projected portions of the contacting surface of heating plate 54 can be aligned with the patterned portion of the ligand-containing resin layer 3. Under this aligned condition, the heating plate 54 is pressed onto the surface of the protective film 4. Incidentally, these heating plates 51 and 54 may be pressed not from the protective film 4 side of fluorescent pattern forming article but from the substrate 1 side.

The heating temperature at the moment of pressing the heating plate onto the surface of protective film 4 of fluorescent pattern forming article may be 80° C. to 150° C. for example, and the pressure at the moment of pressing the heating plate onto the surface of protective film 4 may be 1 Pa to 1 mega (M) Pa. Either heating or pressing may be omitted depending on circumstances. For example, the metal ion-containing resin layer 2 and/or the ligand-containing resin layer 3 is formed of a gel-like material (for example, gelatin or acrylamide compound), the heating may be omitted. A resin which is low in glass transition point is to be employed for the metal ion-containing resin layer 2 or for the ligand-containing resin layer 3, the pressing may be omitted.

When heating or pressing is applied as described above, the ligand represented by the above-described formula (2) and included in the ligand-containing resin layer 3 is enabled to diffuse and, at the same time, the Eu complex represented by the above-described formula (1) and included in the metal ion-containing resin layer 2 is also enabled to diffuse, thus allowing these ligand and Eu complex to approach each other. As a result, the ligand is enabled to coordinate with the Eu ion of the Eu complex, thus allowing the Eu complex represented by the above-described formula (3) to be formed at an interface between the metal ion-containing resin layer 2 and the ligand-containing resin layer 3, or at a region in the vicinity of the interface.

The region in the vicinity of the interface where the Eu complex represented by the above-described formula (3) can be formed may extend throughout the entire thickness of the metal ion-containing resin layer 2 and of the ligand-containing resin layer 3. For example, this region may extend up to a distance of 100 μm from the interface. Further, when the rate of diffusion of the ligand represented by the above-described formula (2) is higher than the rate of diffusion of the complex represented by the above-described formula (1), the formation of Eu complex represented by the above-described formula (3) may be deviated toward the metal ion-containing resin layer 2. On the other hand, when the rate of diffusion of the ligand represented by the above-described formula (2) is lower than the rate of diffusion of the complex represented by the above-described formula (1), the formation of Eu complex represented by the above-described formula (3) may be deviated toward the ligand-containing resin layer 3. The Eu complex represented by the above-described formula (3) is high in intensity of fluorescence, thus enabling the recording of information through this increased intensity of fluorescence.

The read out of the information that has been recorded in the fluorescent pattern forming article of this embodiment can be performed using the following methods. It should be noted that since the fluorescent pattern forming article is substantially transparent to visible light, it is impossible to read out, as it is, the information that has been recorded in the fluorescent pattern forming article. Therefore, ultraviolet rays having a wavelength ranging from 250 nm to 410 nm are irradiated to the fluorescent pattern forming article to enable fluorescence to emit from the region (pattern) where the Eu complex represented by the above-described formula (3) is formed, thus making it possible to read out the fluorescence thus emitted. The read-out of the fluorescence may be performed by means of visual observation or, if required, by making use of an apparatus which is capable of reading the fluorescence, such as a photodiode.

According to the fluorescent pattern forming article of this embodiment, it has been recognized that the intensity of fluorescence at a region where the ligand-containing resin layer 3 is formed is not less than ten times as strong as the intensity of fluorescence of a region where the ligand-containing resin layer 3 is not formed. Namely, it has been found possible to perform the printing which is transparent to visible light but is enabled to emit fluorescence as it is irradiated with ultraviolet rays, thereby exhibiting a high contrast ratio. Accordingly, it is no longer required to adjust the concentration of fluorescent substance or the quantity of ink for the purpose of enhancing the contrast ratio of fluorescence, thus making it possible to obviate any difficulty of adjusting the ink or to inhibit the deterioration of security that might have been caused to occur due to the deformation of printed surface.

Further, according to the fluorescent pattern forming article of this embodiment, it is possible to expect the following effects. First of all, since the ligand-containing resin layer 3 can be formed by means of printing subsequent to the formation of the metal ion-containing resin layer 2, it is possible to additionally write information as required. Further, the read-out of information can be performed through visual observation, without necessitating the employment of a sophisticated detector.

Moreover, by regulating the diffusion coefficient of the metal ion (including the metallic complex) of the metal ion-containing resin layer 12 in the ligand-containing resin layer 13 so as to make it larger than the diffusion coefficient of the ligand of the ligand-containing resin layer 13 in the metal ion-containing resin layer 12, it becomes possible to inhibit the outline of pattern (recording information) of fluorescent compound from being blurred due to excessive diffusion of the metal ion, thus making it possible to create a recording pattern of high-precision.

Next, the method for manufacturing the fluorescent pattern forming article shown in FIG. 1A will be explained. First of all, the metal ion-containing resin layer 2 is formed on the surface of the substrate 1 which is formed of PET resin, glass, etc. The forming of the metal ion-containing resin layer 2 can be performed as follows. Namely, 0.5% by weight of Eu complex and 10% by weight of Dyneon THV 220 (trademark, 3M) are dissolved in ethyl acetate employed as a solvent to prepare a fluorescent ink, which is then coated on the substrate 1 and dried. The fluorescent ink thus coated may be dried by heating it at a temperature of 100° C. The thickness of the fluorescent ink thus coated may be suitably adjusted such that the thickness of the metal ion-containing resin layer 2 after the drying thereof is confined within the range of 1 μm to 100 μm.

Then, the ligand-containing resin layer 3 having a predetermined pattern is formed on the metal ion-containing resin layer 2. In order to form the ligand-containing resin layer 3 having a predetermined pattern, a mask pattern having a negative pattern and formed of metal for example is formed on the surface of the metal ion-containing resin layer 2 and then, a raw material solution for forming the ligand-containing resin layer 3 is coated on aperture portions of the mask pattern and then allowed to dry. Although the film created through the drying of the raw material solution may be left remained on the mask pattern, this residual film can be removed concurrent with the removal of the mask pattern.

As for the raw material solution for forming the ligand-containing resin layer 3, it can be prepared by dissolving 0.5% by weight of phosphine oxide ligand and 10% by weight of Cefral (trademark, Central Glass Co., Ltd.) in xylene employed as a solvent to obtain a ligand ink to be employed as raw material solution for forming the ligand-containing resin layer 3. This ligand ink is then coated as described above and dried. The thickness of the fluorescent ink thus coated may be suitably adjusted such that the thickness of the ligand-containing resin layer 3 after the drying thereof is confined within the range of 1 μm to 100 μm. Incidentally, as for the configuration of the pattern of the ligand-containing resin layer 3, it is conceivable to design such that the pattern is consisted of a plurality of stripes each individually having a width ranging from 100 μm to 1 mm and spaced apart at intervals ranging from 100 μm to 1 mm. Of course, the configuration of the pattern of the ligand-containing resin layer 3 can be variously modified other than those mentioned above.

As for the method of forming the ligand-containing resin layer 3 into a predetermined pattern, it is possible to employ etching using a mask pattern. For example, a mask pattern formed of Teflon (registered trademark) or metal is formed on the surface of the ligand-containing resin layer 3 and then the ligand-containing resin layer 3 is selectively etched through this mask pattern to obtain the predetermined pattern. In this etching step, either wet etching or dry etching can be employed.

As for the method of forming the ligand-containing resin layer 3 into a predetermined pattern without using a mask, it is possible to employ an ink jet printing method. Where a spray coating method is employed, a solvent is removed from the solution during spraying, and hence it is possible to suppress the damage of the lower layer due to the action of the solvent and coordination reaction between the fluorescent substance and ligand to a small revel only in the surface portion.

Any solvent may be used to form a laminate structure unless it dissolve the lower layer during forming each layer, and it is not limit to that used in the Example. As a polymer resin, it is possible to used acryric resin and polycarbonate resin unless it dissolve the upper layer during forming the upper layer.

The metal ion-containing resin layer 2 and ligand-containing resin layer 3 may be formed using a monomer of UV curing resin containing Eu complex or ligand dissolved therein.

Thereafter, a protective film made of PET resin, acrylic resin, polycarbonate resin, aluminum foil, glass, etc., is formed so as to cover the metal ion-containing resin layer 2 and the ligand-containing resin layer 3. As for the method of depositing this protective film, it is possible employ a spin-coating method.

Another method of forming the metal ion-containing resin layer 2 can be performed as follows. Namely, 5% by weight of Eu complex and 25% by weight of acrylic polymer are dissolved in an organic solvent, and the resultant solution is heated to evaporate to dryness, thus forming a polymer containing the Eu complex dispersed therein. Thereafter, the metal ion-containing resin layer 2 is heat-molded on the substrate 1. A heat-molding temperature may be, for example, 120° C. The thickness of the metal ion-containing resin layer 2 may be suitably adjusted within the range of 1 μm to 100 μm.

Incidentally, although europium (Eu) ion is employed in this embodiment as a central metal ion of the metal complex which is a fluorescent compound, it is also possible to employ other kinds of rare earth metal ions. For example, it is possible to employ terbium (Tb) ion, erbium (Er) ion, etc.

As for the ligand to be incorporated into the ligand-containing resin layer 3, the following compounds can be employed. Namely, as for the examples of the ligand to be coordinated with the rare earth metal ion existing in the metal ion-containing resin layer 2, they include not only the aforementioned phosphine oxide compound, but also a compound having a Lewis base substituent group such as a sulfoxy compound, a carboxylic compound, a carbonyl compound, phenanthroline, bipyridine, and a acetylacetonato compound. As for the sulfoxy compound, it is possible to employ alkylsulfoxide (such as dimethylsulfoxide, diethylsulfoxide, etc.). As for the carboxylic compound, it is possible to employ carboxylic acid (acetic acid, butyric acid, etc.). As for the carbonyl compound, it is possible to employ acetone, etc. Further, it is also possible to employ a ligand which is consisted of a compound represented by the following formula (4) (one kind of diphosphine oxide compound).

In this case, a rare earth metal complex (a fluorescent compound) represented by the following formula (5) is created to increase the intensity of fluorescence based on the rare earth metal ion. Especially, when a phosphorus compound having an asymmetric structure selected from the compounds represented by the following formula (4) is coordinated with a single rare earth atom, the ligand field becomes asymmetrical, resulting in a prominent increase in intensity of fluorescence due to the enhancement of the molecular extinction coefficient.

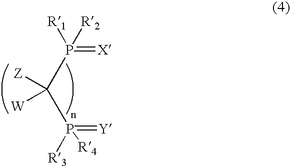

(In formula (4), X′ and Y′ may be the same or different and are individually O, S or Se (especially, O); R′₁ to R′₄ may be the same or different and are individually a straight or branched alkyl or alkoxy group having not more than 20 carbon atoms (for example, alkyl group such as n-Oc(octyl)), phenyl group, biphenyl group, naphthyl group, heterocyclic group, or a substituted group comprising any of these groups (although R′₁ to R′₄ may be the same or different, it is more preferable in terms of luminescent intensity that all of R′₁ to R′₄ are not the same with each other (i.e. the structure is asymmetrical)); n is an integer ranging from 2 to 20 (for example, 3); m and p are respectively an integer ranging from 1 to 5; and Z and W may be the same or different and are individually hydrogen atom, deuterium atom, halogen atom or alkyl group.)

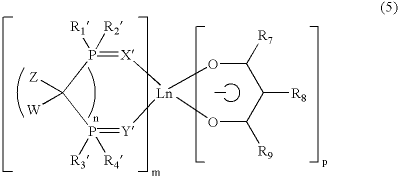

Although a transparent fluorinated polymer such as Cefral (trademark, Central Glass Co., Ltd.) can be generally employed as a transparent resin for the metal ion-containing resin layer 2 and for the ligand-containing resin layer 3, it is also possible to employ other kinds of transparent fluorinated polymer such as Teflon (registered trademark) AF (DuPont Co., Ltd.) and Lumiflon (registered trademark) (Asahi Glass Co., Ltd.), and a fluorinated acrylic resin. It is also possible to employ other kinds of transparent resins other than the transparent fluorinated polymer, specific examples of such transparent resins including acrylic resin, polystyrene, polyester, cycloolefin, etc.

These rare earth metal ions, ligands and transparent resins may be optionally combined. This feature is also applicable to the following embodiments.

It is also possible, in this embodiment, to create a structure where the order of laminating the metal ion-containing resin layer and the ligand-containing resin layer on the substrate is reversed. FIG. 1B shows a cross-sectional view of such a structure, wherein the ligand-containing resin layer 13 is formed on the surface of the substrate, and the metal ion-containing resin layer 12 having a predetermined pattern is formed on the surface of the ligand-containing resin layer 13. Furthermore, the protective film 4 is formed so as to cover the ligand-containing resin layer 13 and the metal ion-containing resin layer 12. This structure can also be prepared according to the method illustrated above, thus making it possible to obtain almost the same effects as obtainable from the structure of FIG. 1A. Additionally, by regulating the diffusion coefficient of the ligand of the ligand-containing resin layer 13 in the metal ion-containing resin layer 12 so as to make it larger than the diffusion coefficient of the metal ion (including the metallic complex) of the metal ion-containing resin layer 12 in the ligand-containing resin layer 13, it becomes possible to inhibit the outline of pattern (recording information) of fluorescent compound from being blurred due to excessive diffusion of the ligand, thus making it possible to create a recording pattern of high-precision.

### Second Embodiment

This second embodiment is characterized in that a partitioning layer (separator layer) is interposed between the metal ion-containing resin layer and the ligand-containing resin layer. FIGS. 2A and 2B respectively illustrates a cross-sectional view of the structure of the fluorescent pattern forming article according to this second embodiment. The components or portions which are the same as those of the FIGS. 1A and 1B will be identified by the same reference numerals in this second embodiment.

As shown in FIG. 2A, a partitioning layer (separator layer) 21 is interposed between the metal ion-containing resin layer 2 and the ligand-containing resin layer 3 for separating these layers from each other. More specifically, this partitioning layer 21 is interposed between the metal ion-containing resin layer 2 and the ligand-containing resin layer 3 and also between the metal ion-containing resin layer 2 and the protective film 4. This partitioning layer 21 plays a role of preventing the ligand existing in the ligand-containing resin layer 3 from diffusing into the metal ion-containing resin layer 2 or plays a role of preventing the metal ion (including the metal complex) existing in the metal ion-containing resin layer 2 from diffusing into the ligand-containing resin layer 3. Of course it is possible to enable the partitioning layer 21 to concurrently exhibit both of these roles.

In the case where the Eu complex represented by the aforementioned formula (1) and the ligand represented by the aforementioned formula (2), which are employed in the first embodiment, are to be employed, the material of the partitioning layer 21 may be selected, for example, from silicone oil, Cefral (trademark, Central Glass Co., Ltd.), a gel-like substance (for example, gelatin, acrylamide, etc.), etc. This partitioning layer 21 can be formed by means of coating or thermocompression bonding. The aforementioned materials for the partitioning layer 21 will be also useful for various combinations between the various kinds of metal ion (including the metal complex) and the various kinds of ligand, which are illustrated in the first embodiment.

In the method of performing the recording of information through the formation of a fluorescent pattern on the fluorescent pattern forming article of this embodiment also, a distribution of the intensity of fluorescence is caused to generate on the surface of fluorescent pattern forming article by externally applying energy of heat or stress to the fluorescent pattern forming article in the same manner as explained with reference to the first embodiment. Namely, through the application of heating or pressing, the ligand of the ligand-containing resin layer 3 is caused to coordinate with the metal ion (including the metal complex) of the metal ion-containing resin layer 2 to thereby form a complex exhibiting a high fluorescent intensity, thereby making it possible to perform the recording of information through this increased fluorescent intensity. In this case, not only the metal ion of the metallic ion-containing resin layer 2 but also the ligand of the ligand-containing resin layer 3 is enabled to diffuse into the partitioning layer 21, thereby enabling the ligand to mainly coordinate with the metal ion existing in this partitioning layer 21. Incidentally, when the rate of diffusion of the ligand represented by the above-described formula (2) is higher than the rate of diffusion of the complex represented by the above-described formula (1), the formation of Eu complex represented by the above-described formula (3) may be deviated toward the metal ion-containing resin layer 2. On the contrary, when the rate of diffusion of the ligand represented by the above-described formula (2) is lower than the rate of diffusion of the complex represented by the above-described formula (1), the formation of Eu complex represented by the above-described formula (3) may be deviated toward the ligand-containing resin layer 3. The Eu complex represented by the above-described formula (3) is high in intensity of fluorescence, thus enabling the recording of information through this increased intensity of fluorescence.

In this embodiment, the heating temperature at the moment of pressing the heating plate onto the surface of protective film 4 of fluorescent pattern forming article may be 80 to 150° C. for example, and the pressure at the moment of pressing the heating plate onto the surface of protective film 4 may be 1 Pa to 1 MPa. As in the case of the first embodiment, either heating or pressing may be omitted depending on circumstances.

According to the fluorescent pattern forming article of this second embodiment, due to the provision of the partitioning layer 21, it is possible to prevent not only the diffusion of the metal ion (including the metal complex) existing in the metallic ion-containing resin layer 2 but also the diffusion of the ligand existing in the ligand-containing resin layer 3. In the case of the first embodiment, due to the fluctuation of external environments such as the fluctuation of outside temperature, the ligand is easily enabled to diffuse and coordinate with the metal ion, thereby occasionally giving rise to the problem that the information that has been recorded is caused to change or disappear. Whereas, according to this second embodiment, since the diffusion of the metal ion or of the ligand can be prevented as described above, it is possible to prevent the changes or disappearance of information that has been recorded or to control the time of change or disappearance of information that has been recorded.

It is also possible, in this embodiment, to create a structure where the order of laminating the metal ion-containing resin layer and the ligand-containing resin layer on the substrate is reversed. FIG. 2B shows a cross-sectional view of such a structure, wherein the ligand-containing resin layer 13 is formed on the surface of the substrate, and the metal ion-containing resin layer 12 having a predetermined pattern is formed, through the partitioning layer 21, on the surface of the ligand-containing resin layer 13. Furthermore, the protective film 4 is formed so as to cover the partitioning layer 21 and the metal ion-containing resin layer 12. This structure can be also prepared according to the method illustrated above, thus making it possible to obtain almost the same effects as obtainable from the structure of FIG. 2A or of FIG. 1B.

### Third Embodiment

This third embodiment is characterized in that a partitioning layer which is interposed between the metal ion-containing resin layer and the ligand-containing resin layer is patterned in conformity with the configuration of the pattern of the metallic ion-containing resin layer or of the ligand-containing resin layer.

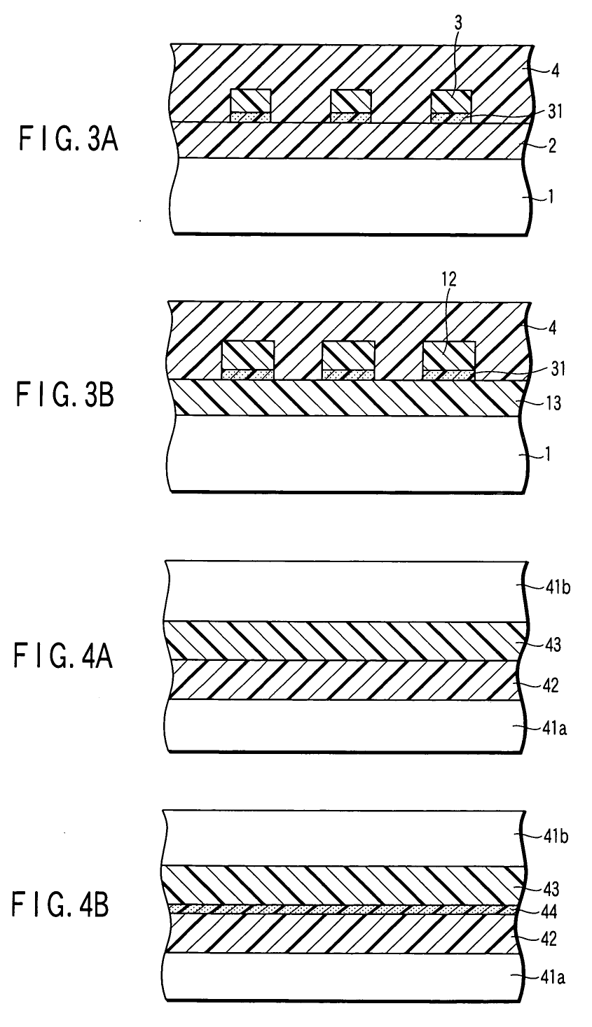

FIGS. 3A and 3B respectively illustrates a cross-sectional view of the structure of the fluorescent pattern forming article according to this third embodiment. The components or portions which are the same as those of the FIGS. 1A and 1B will be identified by the same reference numerals in this third embodiment.

As shown in FIG. 3A, a partitioning layer (separator layer) 31 is interposed between the metal ion-containing resin layer 2 and the ligand-containing resin layer 3 for separating these layers from each other. This partitioning layer 31 is selectively formed in conformity with the regions where the ligand-containing resin layer 3 is formed. As for the method of selectively forming the partitioning layer 31, it is possible to employ a method wherein the metallic ion-containing resin layer 2 is formed on the substrate 1 at first and then a mask pattern having a predetermined configuration is formed on the metallic ion-containing resin layer 2. Thereafter, a film constituting the partitioning layer 31 and the ligand-containing resin layer 3 are successively laminated over the mask pattern and then the mask pattern is removed in the same manner as described in the first embodiment. Alternatively, it is also possible to employ a method wherein the metallic ion-containing resin layer 2, a film constituting the partitioning layer 31 and the ligand-containing resin layer 3 are successively laminated on the substrate 1 and then a mask pattern having a predetermined configuration is formed on the ligand-containing resin layer 3, after which the ligand-containing resin layer 3 and the film constituting the partitioning layer 31 are successively etched away by making use of the mask pattern. The etching of the ligand-containing resin layer 3 can be performed in the same manner as described in the first embodiment. If the partitioning layer 31 is formed of materials exemplified in the second embodiment, the etching thereof can be performed by means of wet etching or dry etching.

According to the fluorescent pattern forming article of this third embodiment, since the diffusion of the metal ion or ligand can be prevented as in the case of the second embodiment, it is possible to prevent the changes or disappearance of information that has been recorded or to control the time of change or disappearance of information that has been recorded. Moreover, since the partitioning layer 31 is interposed exclusively between the metal ion-containing resin layer 2 and the ligand-containing resin layer 3, the range of the metallic ion-containing resin layer 2 where the ligand of the ligand-containing resin layer 3 is enabled to diffuse can be confined to the regions immediately below the ligand-containing resin layer 3. As a result, it is possible to inhibit the outline of pattern (recording information) of fluorescent compound from being blurred due to excessive diffusion of the ligand, thus making it possible to create a recording pattern of high-precision.

It is also possible, in this embodiment, to create a structure where the order of laminating the metal ion-containing resin layer and the ligand-containing resin layer on the substrate is reversed. FIG. 3B shows a cross-sectional view of such a structure, wherein the ligand-containing resin layer 13 is formed on the surface of the substrate 1, and the metal ion-containing resin layer 12 having a predetermined pattern is formed, through the partitioning layer 31, on the surface of the ligand-containing resin layer 13. Furthermore, the protective film 4 is formed so as to cover the partitioning layer 31 and the metal ion-containing resin layer 12. This structure can be also prepared according to the method illustrated above, thus making it possible to obtain almost the same effects as obtainable from the structure of FIG. 3A.

Further, it is also possible to obtain the following effects. Namely, since the partitioning layer 31 is exclusively interposed between the metallic ion-containing resin layer 12 and the ligand-containing resin layer 13, the range where the metal ion of the metallic ion-containing resin layer 12 is enabled to diffuse into the ligand-containing resin layer 13 through the partitioning layer 31 can be confined to the regions immediately below the metallic ion-containing resin layer 12. As a result, it is possible to inhibit the outline of pattern (recording information) of fluorescent compound from being blurred due to excessive diffusion of the metal ion, thus making it possible to create a recording pattern of high-precision.

### Fourth Embodiment

This fourth embodiment is characterized in that the metal ion-containing resin layer and the ligand-containing resin layer are respectively formed as a continuous film and that the patterning of these layers is not performed at all. FIGS. 4A and 4B respectively illustrates a cross-sectional view of the structure of the fluorescent pattern forming article according to this fourth embodiment.

As shown in FIG. 4A, a metallic ion-containing resin layer 42 comprising a transparent resin containing a metal ion is formed, as a first layer, on a substrate 41a functioning as a first base body. The materials and manufacturing method of the metallic ion-containing resin layer 42 may be the same as those employed for the metallic ion-containing resin layer 2 of the first embodiment. A ligand-containing resin layer 43 comprising a transparent resin containing a ligand is formed, as a second layer, on the metallic ion-containing resin layer 42. The materials and manufacturing method of the ligand-containing resin layer 43 may be the same as those employed for the ligand-containing resin layer 13 of the first embodiment. Another substrate 41b is formed, as a second base body, on the ligand-containing resin layer 43 by making use of an adhesive, etc. The materials for the substrate 41a and the substrate 41b may be the same as those employed for the substrate 1 of the first embodiment. However, the substrate 41a and/or the substrate 41b should be substantially transparent to visible light.

Next, there will be explained about the method for performing the recording of information, which can be executed by forming a fluorescent pattern on the fluorescent pattern forming article shown in FIG. 4A. In this embodiment also, a distribution of the intensity of fluorescence is caused to generate on the surface of fluorescent pattern forming article by externally applying energy of heat or stress to the fluorescent pattern forming article of this embodiment. Namely, through the application of heating or pressing, the ligand of the ligand-containing resin layer 43 is caused to coordinate with the metal ion of the metal ion-containing resin layer 42 to thereby form a complex exhibiting a high fluorescent intensity, thereby making it possible to perform the recording of information through this increased fluorescent intensity.

More specifically, the recording of information is performed as follows. First of all, the fluorescent pattern forming article as shown in FIG. 4A is placed on a base plate and then a heating plate is pressed onto the surface of the substrate 41a or the substrate 41b of this fluorescent pattern forming article. The heating plate may be pressed onto both surfaces of the substrate 41a and the substrate 41b. The heating plate to be used may be constructed as shown in FIG. 5B. In this case, the projected portions of the heating plate 54 is aligned with the surface of the substrate 41a and/or the surface of the substrate 41b, and then the heating plate 54 is contacted with one or both of these surfaces. Either heating or pressing may be omitted depending on circumstances. The recording of information can be executed on the regions where the heating or pressing is applied under the same conditions as described in the first embodiment.

According to the fluorescent pattern forming article of this fourth embodiment, it is possible to obtain almost the same effects as obtainable in the first embodiment. Furthermore, since the metallic ion-containing resin layer and the ligand-containing resin layer are not required to be formed into a predetermined pattern, it is possible to expect various effects such as the enhancement of yield in the manufacture of the article and the reduction of manufacturing cost. Additionally, it is also possible to expect the effect that information can be recorded at any desired location of the fluorescent pattern forming article.

In this embodiment, it is also possible to create a structure wherein a partitioning layer (separator layer) 44 is interposed between the metal ion-containing resin layer 42 and the ligand-containing resin layer 43. FIG. 4B show a cross-sectional view of such a structure, wherein the partitioning layer 44 is interposed between the metal ion-containing resin layer 42 and the ligand-containing resin layer 43. This structure can be fabricated by making use of the method explained in the aforementioned embodiments. It is possible, with this structure, to obtain almost the same effects as those explained with reference to the structure of FIG. 4A, or to the structures of the second and third embodiments.

### Fifth Embodiment

This fifth embodiment is characterized in that a reflective film is interposed between the fluorescent pattern forming article and a substrate attached to one of the main surfaces of the article, wherein the recording of information is performed by making use of light. FIGS. 6A and 6B respectively illustrates a cross-sectional view of the structure of the fluorescent pattern forming article according to this fifth embodiment.

As shown in FIG. 6A, a reflective film 64 made of an aluminum vapor deposition film, etc., is formed on the surface of a substrate 61a constituting a first base body and made of PET resin, acrylic resin, polycarbonate resin, etc. On this reflective film 64, there is formed, as a first layer, a metallic ion-containing resin layer 62 formed of a transparent resin containing a metal ion. The materials and manufacturing method of the metallic ion-containing resin layer 62 may be the same as those employed for the metallic ion-containing resin layer 42 of the fourth embodiment. A ligand-containing resin layer 63 formed of a transparent resin containing a ligand is formed, as a second layer, on the metallic ion-containing resin layer 62. The materials and manufacturing method of the ligand-containing resin layer 63 may be also the same as those employed for the ligand-containing resin layer 43 of the fourth embodiment. Another substrate 61b made of PET resin, acrylic resin, polycarbonate resin, etc., is formed, as a second base body, on the ligand-containing resin layer 63 by making use of an adhesive, etc. The substrate 61a and/or the substrate 61b should be substantially transparent not only to visible light but also to the light to be employed for recording as described hereinafter.

Next, there will be explained about the method for performing the recording of information, which can be executed by forming a fluorescent pattern on the fluorescent pattern forming article shown in FIG. 6A. In this embodiment, light is irradiated to the fluorescent pattern forming article of this embodiment from the substrate 61b side (ligand-containing resin layer 63 side), thereby heating the light-irradiated portions of the fluorescent pattern forming article. Due to this heating, a distribution of the intensity of fluorescence is caused to generate on the surface of fluorescent pattern forming article in the same manner as in the case of the first embodiment. Namely, the irradiated portions of the fluorescent pattern forming article are heated by the light directly irradiated thereto and by the absorption of the reflected light from the reflective film 64, and, due to this heating, the ligand of the ligand-containing resin layer 63 is caused to coordinate with the metal ion of the metal ion-containing resin layer 62 to thereby form a complex exhibiting a high fluorescent intensity, thereby making it possible to perform the recording of information through this increased fluorescent intensity.

More specifically, the recording of information is performed as follows. First of all, the fluorescent pattern forming article as shown in FIG. 6A is placed on a base plate and then light is irradiated to predetermined portions of this fluorescent pattern forming article through an exposure mask having a predetermined pattern. In the case where the materials described with reference to FIGS. 1A and 1B of the first embodiment are to be employed, the wavelength of the irradiating light may be confined to the range of 250 nm to 410 nm, and the irradiating intensity thereof may be confined to the range of 100 μW/cm² to 10000 μW/cm².

According to the fluorescent pattern forming article of this fourth embodiment, it is possible to obtain almost the same effects as obtainable in the first embodiment. Furthermore, since the recording of information can be performed by the irradiation of light, the recording of information can be applied to any desired portion of the fluorescent pattern forming article where the light is irradiated. Especially, the metallic ion-containing resin layer as well as the ligand-containing resin layer is not required to be formed into a predetermined pattern, it is possible to expect various effects such as the enhancement of yield in the manufacture of the article and the reduction of manufacturing cost.

In this embodiment, the recording of information can be performed by irradiating light to the fluorescent pattern forming article from the metallic ion-containing resin layer 62 side. FIG. 6B shows a cross-sectional view of such a structure, wherein the metallic ion-containing resin layer 62, the ligand-containing resin layer 63 and the reflective film 64 are successively formed on a substrate 61c functioning as a first base body. On this reflective film 64 is laminated a substrate 61d functioning as a second base body. The materials for the substrate 61c and the substrate 61d may be the same as those employed for the substrate 61a and the substrate 61b. In this structure, the recording of information can be performed by irradiating light from the substrate 61c side (the metallic ion-containing resin layer 62 side).

This structure can be created according to the same method as described in the aforementioned embodiment and almost the same effects as those obtainable from the structure of FIG. 6A can be obtained. Further, since the reflective film 64 is not directly contacted with the metallic ion-containing resin layer 62, the deterioration of effects with time that may be caused to generate due to the direct contact between the reflective film 64 and the metallic ion-containing resin layer 62 can be obviated.

### Sixth Embodiment

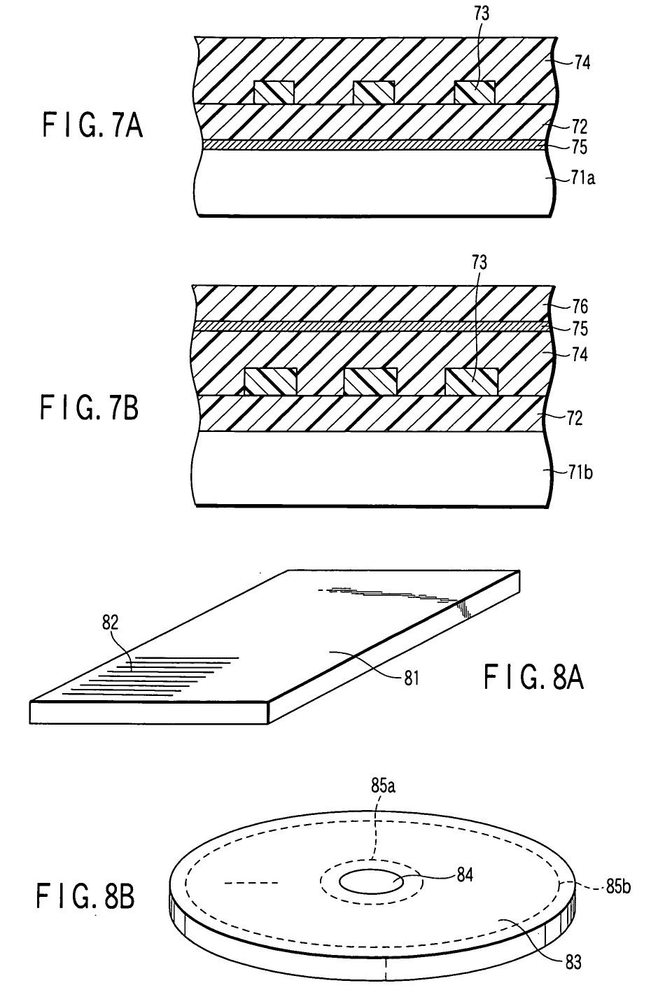

This sixth embodiment is characterized in that the metallic ion-containing resin layer and the ligand-containing resin layer are respectively formed into a predetermined pattern and that a reflective film is provided therein. FIGS. 7A and 7B respectively illustrates a cross-sectional view of the structure of the fluorescent pattern forming article according to this sixth embodiment.

As shown in FIG. 7A, a reflective film 75 is formed on the surface of a substrate 71a constituting a first base body. On this reflective film 75, there is formed, as a first layer, a metallic ion-containing resin layer 72 formed of a transparent resin containing a metal ion. The materials and manufacturing method of the metallic ion-containing resin layer 72 may be the same as those employed for the metallic ion-containing resin layer 2 of the first embodiment. A ligand-containing resin layer 73 formed of a transparent resin containing a ligand is formed, as a second layer, on the metallic ion-containing resin layer 72. The materials and manufacturing method of the ligand-containing resin layer 73 may be also the same as those employed for the ligand-containing resin layer 3 of the first embodiment. A protective film 74 made of PET resin, acrylic resin, polycarbonate resin, etc. is formed so as to cover the metallic ion-containing resin layer 72 and the ligand-containing resin layer 73. This protective film 74 is also substantially transparent not only to visible light but also to the light to be employed for recording. In this embodiment, light is irradiated from the protective film 74 side (the ligand-containing resin layer 73 side) to the fluorescent pattern forming article of this embodiment, thereby performing the recording of information not only at the interface between the ligand-containing resin layer 73 and the metallic ion-containing resin layer 72 but also at the portions where light has been irradiated.

According to the fluorescent pattern forming article of this sixth embodiment, it is possible to obtain almost the same effects as obtainable from the fifth embodiment. Additionally, it is possible, through various combinations between the configuration of pattern of the ligand-containing resin layer 73 and the configuration of pattern of the irradiated light, to form various configurations of pattern of fluorescent compound (recorded information) at a superimposed region of these patterns, thus making it possible to diversify the state of recording.

In this embodiment, the recording of information can be performed by irradiating light to the fluorescent pattern forming article from the metallic ion-containing resin layer 72 side. FIG. 7B shows a cross-sectional view of such a structure, wherein the metallic ion-containing resin layer 72, the ligand-containing resin layer 73, the first protective film 74 and the reflective film 75 are successively formed on a substrate 71b functioning as a first base body. On this reflective film 75 is laminated a second protective film 76. The substrate 71b is substantially transparent not only to visible light but also to the light to be employed for recording. In this structure, the recording of information can be performed by irradiating light from the substrate 71b side (the metallic ion-containing resin layer 72 side).

This structure can be created according to the same method as described in the aforementioned embodiment and almost the same effects as those obtainable from the structures of FIGS. 7A and 6B can be obtained.

### Seventh Embodiment

This seventh embodiment is characterized in that the recorded information is controlled such that, by making use of the diffusion of metal ion or ligand, the intensity of fluorescence is made entirely homogeneous, thus enabling the recorded information to disappear, after a predetermined period of time.

When the fluorescent pattern forming article shown for example in FIG. 1A among the aforementioned embodiments was left to stand for one week, the intensity of fluorescence of the fluorescent pattern forming article was increased all over the surface thereof, thus making it impossible to distinguish the region where the intensity of fluorescence was strengthened in advance from the other region where the intensity of fluorescence was not strengthened in advance. The reason for this seems to be ascribed to the fact that due to the progress of diffusion of the metal ion or the ligand, a metal complex exhibiting a high intensity of fluorescence was caused to form all over the surface of fluorescent pattern forming article. In view of this fact, it is possible to utilize this fluorescent pattern forming article as a security medium or as a recording medium where the information recorded therein can be automatically erased after a predetermined period of time.

The time required to erase the information recorded can be controlled by suitably selecting the material of polymer matrix to be employed for the formation of the metallic ion-containing resin layer 2 and of the ligand-containing resin layer 3, by suitably selecting the material or concentration of metal ion (including metal complex) or of ligand, or by suitably selecting the material or thickness of the partitioning layer of the second embodiment, etc. Of course, it is also possible, through suitable selection of these conditions, to manufacture a fluorescent pattern forming article where the information recorded therein cannot be erased with time. For example, by making use of materials which make the metal ion (including metal complex) or the ligand difficult to diffuse for the formation of the partitioning layer or by making the thickness of the partitioning layer sufficiently thick, it is possible to manufacture a fluorescent pattern forming article where the information recorded therein cannot be erased with time.

Further, it is also possible to manufacture a fluorescent pattern forming article where the information recorded therein can be forcedly erased. For example, the information recorded in the fluorescent pattern forming article can be forcedly erased by promoting the diffusion of metal ion or ligand through the heat treatment of the fluorescent pattern forming article having information recorded therein. The temperature of heat treatment in this case may be confined within the range of 80 to 200° C. for example.

### Eighth Embodiment

This eighth embodiment is characterized in that the recording of information is performed by making use of not only a fluorescent layer containing a fluorescent complex, but also a layer containing a ligand coordinating with the metal ion of the complex to reduce the intensity of fluorescence based on the metal ion. This embodiment will be explained with reference to FIGS. 1A and 1B of the first embodiment.

As shown in FIGS. 1A and 1B, the metal ion-containing resin layer 2 comprising a transparent resin of the same material as in the case of the first embodiment and containing, as a metal ion, trivalent Eu ion (metal complex ion) is formed, as a first layer, on the surface of substrate 1 formed of the same material as in the case of the first embodiment. This metal complex ion includes an acetylacetonato derivative (β-diketone derivative) as represented by the following formula (1) illustrated in the first embodiment and formed into an Eu complex having Eu ion coordinated therewith, this metal complex ion exhibiting fluorescent properties. For example, when Cefral (trademark, Central Glass Co., Ltd.) is employed as a transparent resin, the content of the aforementioned Eu complex in the metal ion-containing resin layer 2 may be 20% by weight.

The ligand-containing resin layer 3 formed of a transparent resin consisting of the same material as described in the first embodiment, containing water and formed into a predetermined pattern is formed, as a second layer, on the surface of the metallic ion-containing resin layer 2. For example, when Cefral (trademark, Central Glass Co., Ltd.) is employed as a transparent resin, the content of the ligand in the ligand-containing resin layer 3 may be 20% by weight. When the ligand of this ligand-containing resin layer 3 is coordinated with the Eu ion of the Eu complex represented by the formula (1) and included in the metallic ion-containing resin layer 2, a complex (a complex reduced in fluorescence) represented by the following formula (6) will be created, thus decreasing the intensity of fluorescence based on Eu ion.

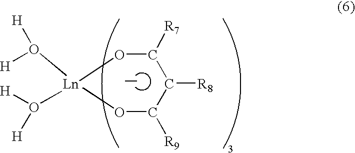

Incidentally, as for the ligand in the ligand-containing resin layer 3, it is possible to employ a hydroxy compound other than water. For example, it is possible to employ lower alcohols such as methanol, ethanol, propanol, etc.

Further, a metal complex (a complex exhibiting a very strong fluorescence) represented by the formula (3) of the first embodiment may be included in the metallic ion-containing resin layer 2 and the water in the ligand-containing resin layer 3 may be coordinated with this metal complex. In this case, in place of the ligand represented by the formula (2) of the first embodiment, water is enabled to coordinate with the central metal ion of the metal complex represented by the formula (3) to form a complex (a complex reduced in fluorescence) represented by the formula (6), thus decreasing the intensity of fluorescence based on Eu ion. In this case, only one of a couple of phosphine oxide compounds (ligands) represented by the formula (2) may be replaced by water molecule. In this case also, the intensity of fluorescence is decreased though the magnitude of decrease in intensity of fluorescence may not be so large as that of the complex represented by the formula (6).

According to the fluorescent pattern forming article of this embodiment also, it has been recognized that the intensity of fluorescence at a region where the ligand-containing resin layer 3 is not formed is not less than ten times as strong as the intensity of fluorescence of a region where the ligand-containing resin layer 3 is formed. Namely, it has been found possible to perform the printing which is transparent to visible light but is enabled to emit fluorescence as it is irradiated with ultraviolet rays, thereby exhibiting a high contrast ratio.

As for the metal ion (including a complex) to be employed in this embodiment, it is possible to employ various kinds of materials other than those described above. For example, it is possible to employ various kinds of metal ion (including complexes) which are described with reference to the first embodiment and the aforementioned hydroxyl compound or water may be coordinated with these metal ions to reduce the intensity of fluorescence.

### Ninth Embodiment

This eighth embodiment is characterized in that the fluorescent pattern forming article of any one of the aforementioned embodiments is mounted on a security card or on a recording medium. FIGS. 8A and 8B respectively shows a perspective view of the structure of the security card or of the recording medium.

As shown in FIG. 8A, the fluorescent pattern forming article 82 of any one of the aforementioned embodiments is mounted on the surface of a security card 81 having a rectangular to surface. The fluorescent pattern forming article 82 can be formed on the top surface of the security card 81 by making use of the method described in the first embodiment for example. According to this security card 81, since it is possible to provide the fluorescent pattern forming article 82 which is transparent to visible light but is enabled to emit fluorescence as it is irradiated with ultraviolet rays and is excellent in contrast ratio, it is no longer required to adjust the concentration of fluorescent substance or the quantity of ink for the purpose of enhancing the contrast ratio of fluorescence, thus making it possible to obviate any difficulty of adjusting the ink or to inhibit the deterioration of security that might have been caused to occur due to the deformation of printed surface.

As shown in FIG. 8B, the fluorescent pattern forming articles 85a and 85b representing any one of the aforementioned embodiments are mounted on the disc-like recording medium 83 in the circumferential direction thereof. Namely, the fluorescent pattern forming article 85a is formed along the innermost periphery of the disc-like recording medium 83 and the fluorescent pattern forming article 85b is formed along the outermost periphery of the disc-like recording medium 83. These fluorescent pattern forming articles 85a and 85b can be formed on the disc-like recording medium 83 in the circumferential direction thereof by the method described in the first embodiment for example. The reference number 84 indicates a holding hole which is formed at a central portion of the disc-like recording medium 83. According to this recording medium 83 also, since it is possible to provide the fluorescent pattern forming articles 85a and 85b which are transparent to visible light but are enabled to emit fluorescence as they are irradiated with ultraviolet rays and are excellent in contrast ratio, it is no longer required to adjust the concentration of fluorescent substance or the quantity of ink for the purpose of enhancing the contrast ratio of fluorescence. As a result, it is possible to obviate any difficulty of adjusting the ink or to inhibit the deterioration of security that might have been caused to occur due to the deformation of printed surface, thus making it possible to enhance the security of information that has been recorded in the recording medium 83.

Incidentally, the present invention should not be construed as being restricted to the aforementioned embodiments. For example, it is possible to manufacture a fluorescent pattern forming article which is capable of emitting a fluorescence of various colors (including white color) through a combination of various kinds of fluorescent substances described in the aforementioned embodiments. Further, in the sixth embodiment, while the metallic ion-containing resin layer may be formed into a predetermined pattern, the ligand-containing resin layer may not be formed into a pattern. Further, in any of the aforementioned embodiments, the metallic ion-containing resin layer and the ligand-containing resin layer may be formed so as to have a pattern of the same configuration.

Further, in any of the aforementioned embodiments, the metal ion (including a central metal ion of metal complex) to be included in the metallic ion-containing resin layer may be selected from the group consisting of indium, gallium, palladium, platinum, ruthenium, copper, zinc and aluminum. In the case where a metal complex containing any of these metal ions as a central metal ion is included in the metallic ion-containing resin layer, the ligand such as an acetylacetonato derivative (β-diketone derivative) described in the first embodiment may be coordinated with the metal ion. In this case, the ligand to be included in the ligand-containing resin layer may be selected from the compounds having a Lewis base substituent group such as a sulfoxy compound, a carboxylic compound, a carbonyl compound, phenanthroline, bipyridine and a acetylacetonato compound as described in the first embodiment.

The present invention should not be construed as being limited to the foregoing embodiments. Namely, the constituent elements of the present invention can be variously modified in practicing the present invention within the scope of the invention. Further, a plurality of constituent elements disclosed in the foregoing embodiments may be optionally combined to create various forms of invention. For example, some of the constituent elements illustrated in the foregoing embodiments may be eliminated. Furthermore, the constituent elements illustrated in different embodiments described above may be optionally combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fluorescent pattern forming article comprising:
a first layer containing a metal ion; and
a second layer disposed facing the first layer and containing a ligand coordinating with the metal ion contained in the first layer to thereby enable an intensity of fluorescence based on the metal ion to be changed.

2. The fluorescent pattern forming article according to claim 1, which further comprises a partitioning layer interposed between the first and second layers for separating these layers from each other.

3. A fluorescent pattern forming article comprising:
a first layer containing a metal ion;
a second layer disposed facing the first layer and containing a ligand coordinating with the metal ion contained in the first layer to thereby enable an intensity of fluorescence based on the metal ion to be increased; and
a third layer interposed between the first and second layers and containing a fluorescent compound having the metal ion and the ligand coordinated with the metal ion, said fluorescent compound being formed into a pattern.

4. The fluorescent pattern forming article according to claim 3, in which a part of the third layer has a function to separate the first layer from the second layer.

5. The fluorescent pattern forming article according to claim 3, wherein the metal ion contained in the first layer and/or the ligand contained in the second layer is capable of diffusing into a region other than the pattern of the fluorescent compound interposed between the first and second layers to thereby enable the intensity of fluorescence based on the metal ion to become homogeneous throughout the entire surface with time.

6. A fluorescent pattern forming article comprising:
a first layer containing a first complex having a metal ion and fluorescent properties and functioning as a fluorescent layer;
a second layer disposed facing the first layer and containing a ligand coordinating with the metal ion of the first complex contained in the first layer to thereby enable an intensity of fluorescence based on the metal ion to be decreased; and
a partitioning layer interposed between the first and second layers for separating these layers from each other, said partitioning layer containing a second complex having the ligand coordinated with the metal ion of the first complex, said second complex being formed into a pattern.

7. The fluorescent pattern forming article according to claim 6, wherein the first complex contained in the first layer and/or the ligand contained in the second layer is capable of diffusing into a region other than the pattern of the second complex interposed between the first and second layers to thereby enable the intensity of fluorescence based on the metal ion to become homogeneous throughout the entire surface with time.

8. The fluorescent pattern forming article according to claim 1, wherein the first layer and/or the second layer is formed into a pattern.

9. The fluorescent pattern forming article according to claim 8, which further comprises a partitioning layer interposed between the first and second layers for separating these layers from each other, said partitioning layer being formed into a pattern corresponding to at least one of the patterns of the first layer and/or the second layer.

10. The fluorescent pattern forming article according to claim 8, which further comprises a protective layer for covering the first layer and/or the second layer that has been formed into the pattern.

11. The fluorescent pattern forming article according to claim 1, which further comprises a supporting substrate attached respectively to the first layer and/or the second layer.

12. The fluorescent pattern forming article according to claim 1, which further comprises a supporting substrate attached respectively to the first layer and/or the second layer, and a reflective film interposed between the supporting substrate and the first layer and/or the second layer.

13. The fluorescent pattern forming article according to claim 1, which further comprises a transparent substrate attached respectively to one main surface of the first layer and/or the second layer, and a reflective film attached respectively to the other main surface of the first layer and/or the second layer.

14. The fluorescent pattern forming article according to claim 3, wherein the fluorescent compound is capable of emitting fluorescence as it is irradiated with ultraviolet rays and is substantially transparent to visible light.

15. The fluorescent pattern forming article according to claim 1, wherein the first layer and/or the second layer is substantially transparent to visible light.

16. The fluorescent pattern forming article according to claim 1, which further comprises a partitioning layer interposed between the first and second layers for separating these layers from each other, the partitioning layer being substantially transparent to visible light.

17. The fluorescent pattern forming article according to claim 1, wherein the metal ion is formed of at least one kind of metal selected from the group consisting of rare earth metals, indium, gallium, palladium, platinum, ruthenium, copper, zinc and aluminum.

18. The fluorescent pattern forming article according to claim 1, wherein the metal ion is contained as a metal ion complex in the first layer.

19. The fluorescent pattern forming article according to claim 1, wherein the ligand acts to increase the intensity of fluorescence based on the metal ion as it is coordinated with the metal ion of the first layer, the ligand being at least one kind of compound selected from the group consisting of a phosphine oxide compound, a sulfoxy compound, a carboxylic compound, a carbonyl compound, phenanthroline, bipyridine, and a acetylacetonato compound.

20. The fluorescent pattern forming article according to claim 1, wherein the ligand acts to decrease the intensity of fluorescence based on the metal ion as it is coordinated with the first complex of the first layer, the ligand being at least one compound selected from the group consisting of a hydroxy compound and water.

21. A recording medium which is capable of recording information as a distribution of fluorescent intensity, the recording medium comprising:
a first layer containing a metal ion; and
a second layer disposed facing the first layer and containing a ligand coordinating with the metal ion contained in the first layer, to thereby enable an intensity of fluorescence based on the metal ion to be changed.

22. A security medium which is capable of recording security information as a distribution of fluorescent intensity, the security medium comprising:
a first layer containing a metal ion; and
a second layer disposed facing the first layer and containing a ligand coordinating with the metal ion contained in the first layer, to thereby enable an intensity of fluorescence based on the metal ion to be changed.

23. A recording method for performing recording of information onto a fluorescent pattern forming article comprising a first layer containing a metal ion; and a second layer disposed facing the first layer and containing a ligand coordinating with the metal ion contained in the first layer and enabling an intensity of fluorescence based on the metal ion to be changed; the method comprising:
externally applying at least one kind of energy selected from the group consisting of heat, stress and light to the fluorescent pattern forming article to enable the ligand of the second layer to be coordinated with the metal ion contained in the first layer, thereby changing the intensity of fluorescence to perform the recording of information.
